(19) United States
(12) Patent Application Publication
(10) Pub. No.: US 2014/0241701 A1
(43) Pub. Date: Aug. 28, 2014

(54) IMAGE PROCESSING APPARATUS, COMPUTER-READABLE MEDIUM STORING AN IMAGE PROCESSING PROGRAM, AND IMAGE PROCESSING METHOD

(71) Applicant: NK WORKS CO., LTD., Wakayama-shi (JP)

(72) Inventors: Tomoo Nakano, Wakayama-shi (JP); Koji Kita, Wakayama-shi (JP)

(73) Assignee: NK WORKS CO., LTD., Wakayama-shi (JP)

(21) Appl. No.: 14/187,631

(22) Filed: Feb. 24, 2014

(30) Foreign Application Priority Data
Feb. 25, 2013 (JP) 2013-034917

(51) Int. Cl. G11B 27/031; G11B 27/28

(52) U.S. Cl. CPC G11B 27/031; G11B 27/28
USPC 386/281

(57) ABSTRACT

An image processing apparatus is provided. The image processing apparatus includes a storage unit having a first storage area and a second storage area, as well as an output processing unit, a record storage unit, and a display control unit. The output processing unit executes output processing for exporting and/or printing on one or more frames selected by a user from a video stored in the first storage area. The record storage unit stores, in the second storage area, a record of the output processing that includes an identifier for each frame that was subjected to the output processing. The display control unit references the second storage area and displays a record screen for displaying the record of the output processing.

### FIELD OF INVENTION

The present invention relates to an image processing apparatus, a computer-readable medium storing an image processing program, and an image processing method.

### BACKGROUND

Conventionally, a technique of sequentially executing image processing on a target image and storing the contents thereof as a record is publicly-known (e.g., see JP 2009-225359A). If this kind of image processing record is later referenced, for example, the origin of the target image resulting from the image processing can be known, and it is possible to find out if the target image has been subjected to an unauthorized operation such as tampering. Accordingly, this record storage function is useful in the case where, for example, an image that is evidentiary material is analyzed using image processing and stored by an organization such as the police during an investigation of a crime, or the like.

Incidentally, it is important to record the origin of an image and also unauthorized operations such as tampering, and as in the aforementioned example, if the target image is confidential information, it is also important to manage outflow of the image data. In view of this, conventionally, if a data file stored in a computer is printed by a printer, a log of the print processing is sometimes kept by the operating system (OS) of the computer or the printer.

However, the conventional log function is not necessarily sufficient in the case of managing a video that includes multiple frames. This is because the conventional log function often specifies and records the targets of print processing in units of files. Accordingly, a problem can arise in that if a portion of the frames included in the video are captured and printed, it cannot be known which frames were printed.

Also, for the purpose of managing the outflow of image data, the above problem applies not only to the case of executing print processing, but also to the case where export processing is executed by application software that manages the image data.

### SUMMARY of INVENTION

It is an object of the present invention to provide an image processing apparatus, a computer-readable medium storing an image processing program, and an image processing method that enable appropriate management of the outflow of image data in a situation where video data is handled.

An image processing apparatus according to a first aspect includes a storage unit having a first storage area and a second storage area, as well as an output processing unit, a record storage unit, and a display control unit. The output processing unit executes output processing for exporting and/or printing on one or more frames selected by a user from a video stored in the first storage area. The record storage unit stores, in the second storage area, a record of the output processing that includes an identifier for each frame that was subjected to the output processing. The display control unit references the second storage area and displays a record screen for displaying the record of the output processing.

Here, the user can select one or more frames included in the video and output (export and/or print) them. Then, when this kind of output processing is executed, a record specifying the target of the output processing in units of frames is kept. Furthermore, the output record is presented to the user. Accordingly, the user can know which frames were output even if only a portion of the frames included in the video were output. As a result, the outflow of image data can be managed appropriately in a situation where video data is handled.

An image processing apparatus according to a second aspect is the image processing apparatus according to the first aspect, where the display control unit displays a timeline object that schematically illustrates a timeline of the video, when the user selects a specific area on the timeline object, the display control unit displays a frame corresponding to the specific area, and when the user selects a record of specific output processing on the record screen, the display control unit displays, on the timeline object, an area corresponding to the frame that was subjected to the specific output processing, such that the area is distinguished from areas corresponding to the other frames.

Here, by selecting a specific area on the timeline object that schematically illustrates the timeline of the video, the user can cause the frame corresponding to that area in the video to be displayed. Also, by selecting a specific output record on the record screen, the user can cause the area corresponding to the frame that was subjected to the output processing corresponding to that output record to be displayed on the timeline object such that the area is distinguished from the areas corresponding to the other frames. Note that “displaying such that an area is distinguished from another area” mentioned here refers to displaying both areas in different display formats (using different colors, patterns, or the like) for example. Accordingly, the user selects a specific output record on the record screen, and by subsequently referencing the timeline object, the user can easily understand the position on the timeline of the frame that was subjected to the output processing corresponding to that output record. Furthermore, by selecting the area visually corresponding to the frame that was subjected to the output processing on the timeline object, the user can cause the frame that was subjected to the output processing to be displayed. Accordingly, the user can easily check the image data that may possibly have been taken out.

An image processing apparatus according to a third aspect is the image processing apparatus according to the first aspect or the second aspect, further including an image processing unit. The image processing unit carries out a type of image processing selected by the user from a plurality of types of image processing on one or more frames selected by the user from the video stored in the first storage area.

Here, the user can carry out various types of image processing on one or more frames included in the video.

An image processing apparatus according to a fourth aspect is an image processing apparatus according to any of the first to third aspects, where the record of the output processing that is stored in the second storage area does not include image data of the frame that was subjected to the output processing.

Here, the image data itself of the frame that was subjected to the output processing is not stored as the output record. Accordingly, the amount of storage space that is needed to keep output records is reduced.

An image processing apparatus according to a fifth aspect is an image processing apparatus according to any of the first to fourth aspects, further including a change unit. The change unit changes the identifier of one or more frames included in the video that is stored in the first storage area. The record management unit, in accordance with the change, changes the identifier of the one or more frames included in the record of the output processing that is stored in the second storage area.

Here, when the identifier for a frame in the storage area storing the data for the video (the first storage area) is changed, the identifier for that frame in the storage area storing the output record for the video (the second storage area) is changed accordingly. That is to say, changes in the identifier of the latter frame are linked to changes in the identifier of the former frame. Accordingly, even if the identifier of the former frame is changed, no discrepancy will occur between the identifiers of the frames. Note that one conceivable situation where the identifier of the former frame is changed is a case in which a frame is deleted or added on the video timeline and thereby the positions of the frames on the timeline that are used as all or part of the identifiers of the frames are changed automatically. Alternatively, a case is also conceivable in which the name of the video and/or the name of the frame that is used as all or part of the identifiers for the frames is changed by the user, or the like.

A non-transitory computer-readable medium according to a sixth aspect stores an image processing program. The image processing program causes a computer having a first storage area and a second storage area to execute a step of executing output processing for exporting and/or printing one or more frames selected by a user from a video stored in the first storage area, a step of storing, in the second storage area, a record of the output processing that includes an identifier for each frame that was subjected to the output processing, and a step of referencing the second storage area and displaying a record screen that displays the record of the output processing. Here, an effect similar to that of the first aspect can be demonstrated.

An image processing method according to a seventh aspect is an image processing method for executing image processing using a computer that has a first storage area and a second storage area, the method including a step of executing output processing for exporting and/or printing one or more frames selected by a user from a video stored in the first storage area, a step of storing, in the second storage area, a record of the output processing that includes an identifier for each frame that was subjected to the output processing, and a step of referencing the second storage area and displaying a record screen that displays the record of the output processing. Here, an effect similar to that of the first aspect can be demonstrated.

### Advantageous Effects of Invention

According to the present invention, the user can select one or more frames included in the video and output (export and/or print) them. Then, when this kind of output processing is executed, a record specifying the target of the output processing in units of frames is kept. Furthermore, the output record is presented to the user. Accordingly, the user can know which frame was output even if only a portion of the frames included in the video were output. As a result, the outflow of image data can be managed appropriately in a situation where video data is handled.

### BRIEF DESCRIPTION OF DRAWINGS

FIG. 1 is a block diagram of an image processing apparatus according to an embodiment of the present invention;

FIG. 2 is a diagram of a basic screen before image data is imported;

FIG. 3 is a diagram of a basic screen after image data is imported;

FIG. 4 is a diagram showing a group of still images belonging to one timeline;

FIG. 5 is a diagram showing a history screen;

FIG. 6 is another diagram showing a history screen;

FIG. 7 is a diagram showing the data structure of an output management table;

FIG. 8 is a diagram showing an output record screen;

FIG. 9 is a diagram showing another output record screen;

FIG. 10 is a diagram showing yet another output record screen; and

FIG. 11 is a diagram showing yet another output record screen.

### DETAILED DESCRIPTION OF THE PREFERRED EMBODIMENTS

Hereinafter, an image processing apparatus, a computer-readable medium storing an image processing program and an image processing method according to an embodiment of the present invention will be described with reference to the drawings.

1. Overview of Image Processing Apparatus

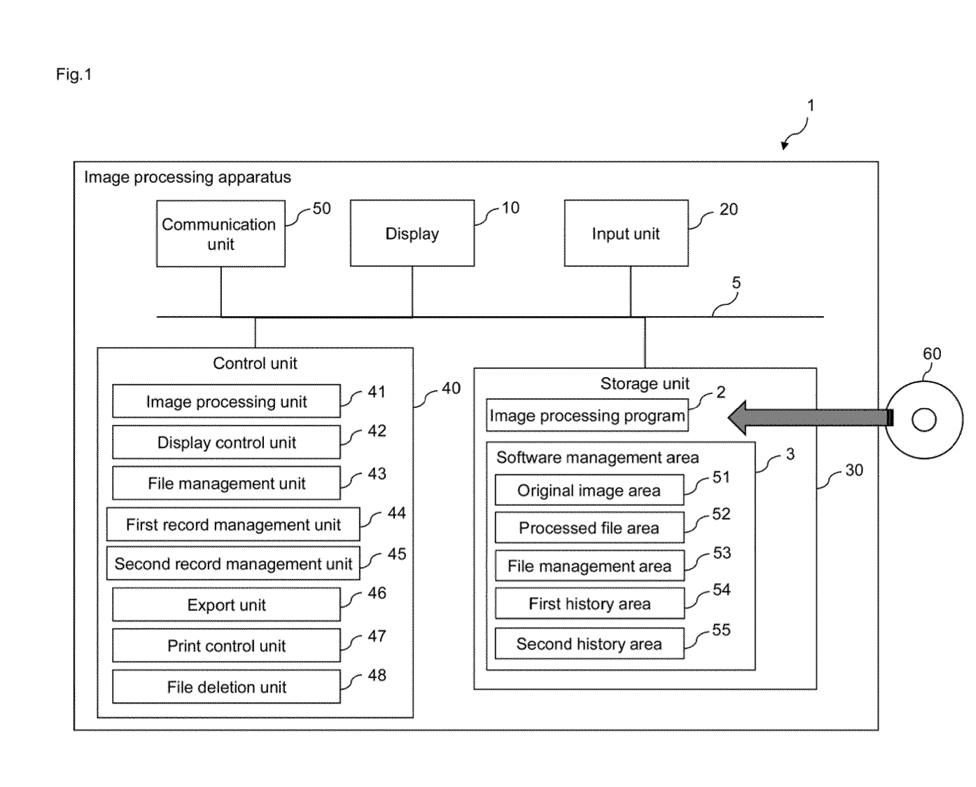

An image processing apparatus 1 shown in FIG. 1 is one embodiment of an image processing apparatus according to the present invention. The image processing apparatus 1 is a general-purpose personal computer. An image processing program 2 that is one embodiment of an image processing program according to the present invention is provided and installed in the image processing apparatus 1 via, for example, a computer-readable recording medium 60 such as a CD-ROM, a DVD-ROM and an USB memory that stores the image processing program 2. The image processing program 2 is application software for supporting image processing performed on moving images and still images. The image processing program 2 causes the image processing apparatus 1 to execute steps included in operations that will be described later.

The image processing apparatus 1 has a display 10, an input unit 20, a storage unit 30, a control unit 40, and a communication unit 50. The display 10, the input unit 20, the storage unit 30, the control unit 40 and the communication unit 50 can appropriately communicate with each other due to being connected to each other via a bus line or cable 5, for example.

In the present embodiment, the display 10 is configured by a liquid crystal display or the like and displays later-described screens and the like to a user. The input unit 20 is configured by a mouse and a keyboard, or the like and receives operations performed by the user on the image processing apparatus 1. The storage unit 30 is a non-volatile storage area configured by hard disk or the like. The control unit 40 is configured by a CPU, a ROM and a RAM, or the like. The communication unit 50 is configured by a LAN port and an USB port, or the like and is a communication interface that enables communication between external devices and the image processing apparatus 1 via LAN, Internet, dedicated line, or the like.

The image processing program 2 is stored in the storage unit 30. A software management area 3 is secured in the storage unit 30. The software management area 3 is an area used by the image processing program 2. An original image area 51, a processed file area 52, a file management area 53, a first history area 54 and a second history area 55 are secured in the software management area 3. The roles of these areas 51 through 55 will be described later.

The control unit 40 operates in a virtual manner as an image processing unit 41, a display control unit 42, a file management unit 43, a first record management unit 44, a second record management unit 45, an export unit 46, a print control unit 47, and a file deletion unit 48, by reading out and executing the image processing program 2 stored in the storage unit 30. The operations of the units 41 to 48 will be described later.

2. Detailed Description of Configuration and Operations of Image Processing Apparatus

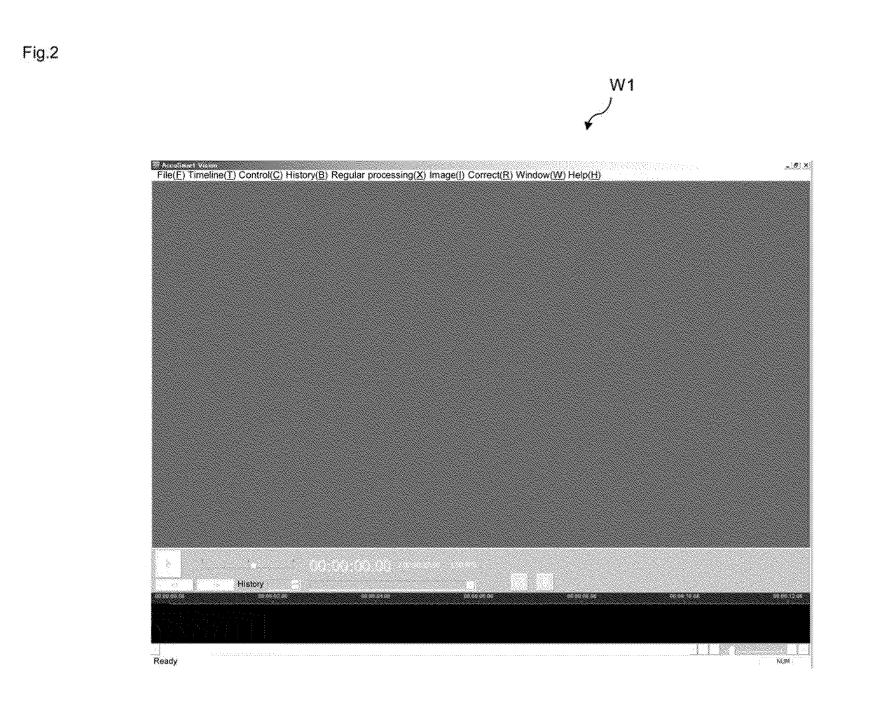

The control unit 40 starts the image processing program 2 upon detecting that the user has performed a predetermined operation via the input unit 20. When the image processing program 2 has been started, a basic screen W1 (see FIG. 2) is displayed on the display 10. Note that the display control unit 42 controls the display of screens, windows, buttons and all other elements that are displayed on the display 10.

2-1. Import of Image Data

The basic screen W1 receives an instruction to import image data to the original image area 51 from a user. Image data imported to the original image area 51 is targeted for later-described playback processing, image processing, export processing and print processing. The control unit 40 imports image data to the original image area 51 from a still image file or a moving image file. Note that in this specification, still image files are data files in a still image format, and moving image files are data files in a moving image format.

In the case of importing image data from a still image file, the user designates one still image file or one folder by operating the input unit 20. In the case of the former, the control unit 40 prompts the user to input a filename and an address path in the storage unit 30 for that still image file. In the case of the latter, the control unit 40 prompts the user to input a folder name and an address path in the storage unit 30 for that folder. Thereafter, the control unit 40 saves the designated still image file or all the still image files in the designated folder as a still image file group in the original image area 51. Note that the term “group” used in this specification is not limited to being made up of multiple elements, and may be made up of one element.

On the other hand, in the case of importing image data from a moving image file, the user inputs a filename and an address path in the storage unit 30 for one moving image file by operating the input unit 20. The display control unit 42 displays a moving image import window (not shown) in a superimposed manner on the basic screen W1 upon detecting that the user designated a moving image file. The moving image import window receives the selection of a segment of arbitrary length from the user, out of the entire segment of the timeline of the designated moving image file. Upon detecting that the user selected a specific segment via the input unit 20, the control unit 40 generates a still image file group that corresponds on a one-to-one basis to the group of frames included in that segment of the designated moving image file. Thereafter, the control unit 40 saves this still image file group in the original image area 51. Accordingly, in the present embodiment, the image data targeted for later-described playback processing, image processing, export processing and print processing is not a moving image file, but rather still image files.

Note that even if a still image file group imported to the original image area 51 originates from still image files rather than from a moving image file, the control unit 40 recognizes the still image file group as being a group of still image files that are included in a moving image and are arranged in a timeline. The arrangement is, when the still image file group imported to the original image area 51 originates from a moving image file, determined so that it is as the original arrangement in the original moving image file. When the still image file group imported to the original image area 51 originates from still image files, the arrangement is automatically determined based on file attributes (filename, created on date/time, updated on date/time, or the like) of the original still image files. The arrangement determined here is managed in the file management area 53 by the file management unit 43.

Specifically, each time processing for importing a still image file group to the original image area 51 is executed, the file management unit 43 generates one timeline identifier (referred to below as a “timeline ID”). Also, each time one timeline ID is generated, the file management unit 43 creates one timeline file storing that timeline ID and stores the file in the file management area 53. The timeline file stores the timeline ID and the identifiers for all of the still image files belonging to the timeline identified by that timeline ID (referred to below as “image file IDs”). Furthermore, the timeline file stores each image file ID in association with a frame order n on the timeline. More specifically, the image file ID of a still image file that is the n-th frame on the timeline is stored in association with a value n in the timeline file storing the timeline ID of that timeline. Note that the frame identifier (referred to below as the “frame ID”) is a combination of the timeline ID and the value n. According to the above description, the timeline file can be said to be a file for managing the frame IDs of still image files that are stored in the original image area 51 and the processed file area 52.

2-2. Playback Processing

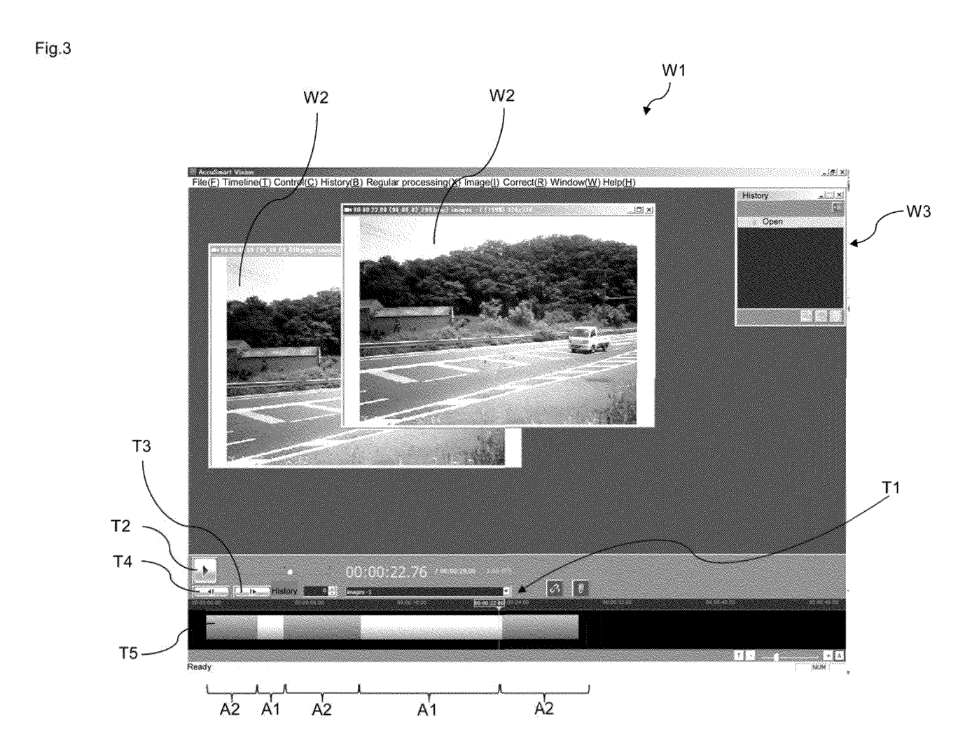

When a still image file group is imported to the original image area 51, the display control unit 42 displays a display window W2 (see FIG. 3) in a superimposed manner on the basic screen W1. The number of display windows W2 that are created is the same as the number of timelines of the still image file groups that were imported to the original image area 51.

First, one still image file included in the still image file group imported to the original image area 51 (e.g., the still image file corresponding to the first frame on the timeline) is displayed in the display window W2. Thereafter, the frame that is displayed in the display window W2 is switched based upon a user operation, as will be described later.

As shown in FIG. 3, a window selection pull-down menu T1, a play button T2, a frame advance button T3, a frame reverse button T4, and a timeline bar T5 are arranged on the basic screen W1.

Even if there are multiple display windows W2, there is only one active display window W2. The window selection pull-down menu T1 receives a user selection of which display window W2 is to be made active. Hereinafter, the timeline that corresponds to the active display window W2 is referred to as the active timeline, and frame group that belongs to the active timeline is referred to as the active frame group. Also, the frame currently displayed in the active display window W2 is referred to as the active display frame.

The active frame group can be played back as a moving image in the active display window W2 by the display control unit 42. The play button T2 receives a user instruction to play back the active frame group as a moving image. Upon detecting that the user has pressed the play button T2 via the input unit 20, the display control unit 42 displays the frames included in the active frame group sequentially along the timeline in the active display window W2 in a frame advance format. Note that playback starts from the active display frame at the point in time when the play button T2 is pressed. Also, the play button T2 receives a user instruction to stop playback. Upon detecting that the user has pressed the play button T2 via the input unit 20 during playback, the display control unit 42 fixes the display in the active display window W2 to the active display frame at that point in time.

The frame advance button T3 and the frame reverse button T4 respectively receive user instructions to switch the active display frame to the next frame and the previous frame along the active timeline.

The timeline bar T5 is an object that diagrammatically represents the active timeline. The timeline bar T5 is equally divided in the direction in which the bar extends, the number of the divided areas being the same as the number of frames included in the active frame group. An n-th divided area from the left on the timeline bar T5 corresponds to the n-th frame on the active timeline (where n is a natural number).

The timeline bar T5 receives a user selection of an arbitrary segment on the active timeline. The segment to be selected may be a continuous section, or may be a discontinuous section as shown in FIG. 3. In other words, the user can select any number of any frames out of all the frames of the active frame group by operating the timeline bar T5 through the input unit 20. Specifically, the user selects (for example click) a divided area corresponding to a frame that he/she desires to select on the timeline bar T5. It is possible to select a plurality of divided areas at the same time.

As shown in FIG. 3, divided areas A1 corresponding to a selected frame group and divided areas A2 corresponding to a non-selected frame group are displayed in a different manner in the timeline bar T5 by the display control unit 42. The selected frame group is the frame group that corresponds to the segment that is currently selected on the active timeline. The non-selected frame group is the frame group that corresponds to the segment that is not currently selected on the active timeline. In the present embodiment, the area A1 is displayed in a light tone of color, and the area A2 is displayed in a dark tone of color.

The image processing unit 41 recognizes the selected frame group as being the target of later-described image processing. Also, the export unit 46 and the print control unit 47 recognize the selected frame group respectively as being the targets of later-described export processing and print processing. Note that each time a divided area on the timeline bar T5 is selected by the user, the active display frame is switched to the frame that corresponds to the most recently selected divided area by the display control unit 42.

2-3. Image Processing

Hereinafter, image processing by the image processing unit 41 will be described. The target of image processing is the selected frame group. The image processing unit 41 can execute multiple image processing modules such as noise removal, sharpness, brightness/contrast/saturation adjustment, image resolution adjustment, image averaging, rotation, and the addition of characters/arrows/mosaic. The image processing modules are incorporated in the image processing program 2.

By operating the basic screen W1 via the input unit 20, the user can select any of the image processing modules any number of times in any order. When selecting an image processing module, the user inputs a parameter to be needed to execute the image processing module. Each time the image processing unit 41 detects that the user selected an image processing module, it executes that image processing module on the selected frame group at that point in time. That is, selecting the image processing module by a user means that he or she instructs to execute that image processing module. Note that the execution of an image processing module on a selected frame group refers to the execution of that image processing module on each frame included in that selected frame group.

As image processing modules are executed on a frame sequentially, that is, once, twice, thrice, and so on, that frame is sequentially manipulated into a first-order frame, a second-order frame, a third-order frame, and so on. A 0-th-order frame corresponds to a still image file saved in the original image area 51. An (m+1)-th-order frame corresponds to a still image file obtained after an image processing module has been executed once on a still image file corresponding to an m-th-order frame (where m is an integer greater than or equal to 0). The image processing unit 41 sequentially generates still image files that correspond to the first-order and subsequent frames, and saves those still image files individually in the processed file area 52.

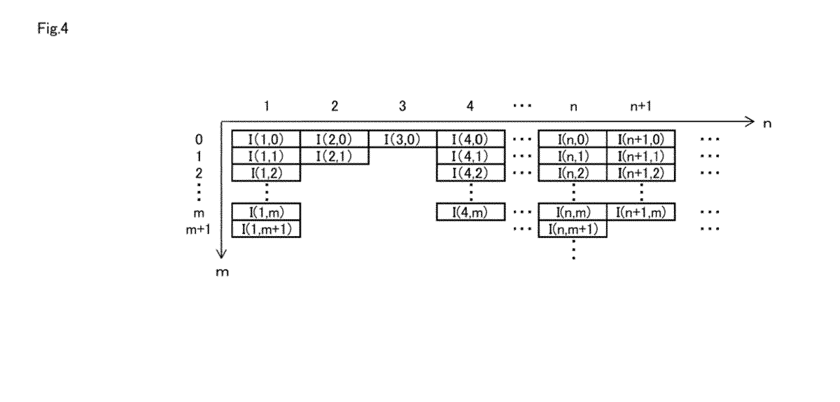

FIG. 4 is a conceptual diagram showing how a group of still images belonging to one timeline is managed by the image processing program 2. In FIG. 4, an N axis, which is the horizontal axis, represents the order of the frames on the timeline, and an M axis, which is the vertical axis, represents the order of processing. The box corresponding to the coordinates (n,m) in an N-M space in FIG. 4 represents the still image I (n,m). The still image I (n,m) is the m-order still image of the n-th frame on the timeline (where n is a natural number, and m is an integer greater than or equal to 0).

The file management unit 43 stores the image file IDs of still images resulting from the execution of an image processing module by adding them in the timeline file storing the image file IDs of the still images on which the image processing module had not yet been executed. Accordingly, the timeline file stores the image file IDs of all still images belonging to the corresponding timeline. More specifically, the image file ID of a still image I (n, m) is stored in the timeline file in association with the frame order n and the processing order m on the corresponding timeline.

Furthermore, for each frame on the corresponding timeline, or in other words, for each n, the value of the currently-selected coordinate m is managed in real time as a parameter mₛ in the timeline file. Immediately after the still image file group is imported to the original image area 51, the coordinate mₛ of all frames in that still image file group is the initial value 0. Thereafter, each time an image processing module is executed one time, the coordinate mₛ of that frame is incremented by one. Also, as will be described later, the user can freely change the coordinate mₛ of any frame.

The execution of an image processing module on a frame refers to the execution of that image processing module on a still image at the currently-selected coordinate mₛ of that frame. Accordingly, each time an image processing module is executed, the image processing unit 41 references the file management area 53 so as to specify the still image that is to be the target.

2-4. Image Processing Record Management

For each frame, the first record management unit 44 manages a history file corresponding to that frame in the first history area 54. The history file stores records of image processing modules that have been executed on the frame corresponding to that history file. A record of image processing modules in the present embodiment is information indicating the types of the image processing modules, the order in which the image processing modules were executed, and which parameters were used in their execution. Each time an image processing module is executed, the first record management unit 44 automatically updates the content of the history file corresponding to the frame that was subjected to that image processing module.

Specifically, the history file stores the frame ID of the frame corresponding to that history file. Note that as described above, a frame ID is a value obtained by combining the timeline ID and the frame order n on the timeline. Also, the history file stores, in association with the processing order m, the processing content (in the present embodiment, the name and parameters of the image processing module) of the image processing module that has been executed on the m-th order still image of the frame corresponding to that history file.

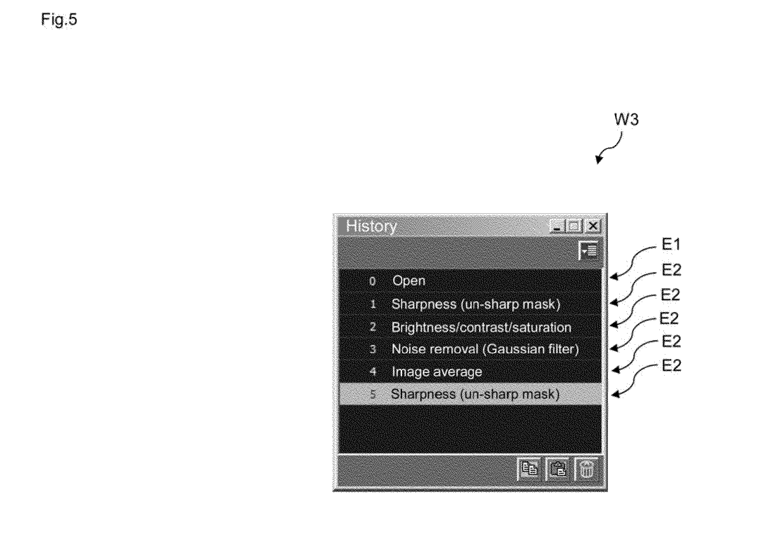

As shown in FIG. 3, the display control unit 42 can display a history window W3 in an overlapping manner on the basic screen W1. The history window W3 displays the details of the image processing for the active display frame (see FIG. 5). The details of the image processing displayed in the history window W3 are determined by referencing the first history area 54. Note that each time the active display frame is switched, the display in the history window W3 is also switched in real time.

As shown in FIG. 5, an initial state area E1 and module name areas E2 are displayed in a vertical list in the history window W3. There is one initial state area E1, and the number of module name areas E2 is the same as the number of image processing modules that have been executed on the active display frame. The initial state area E1 corresponds to the initial state of the active display frame (the 0-th order frame). The I-th module name area E2 from the top corresponds to the I-th image processing module that was executed on the active display frame (I being a natural number). Each module name area E2 displays the name of the image processing module corresponding to that area E2. Also, when a specific area E2 is selected in the history window W3 due to the user performing an operation on the input unit 20, the display control unit 42 displays, in an overlapping manner on the basic screen W1, a window (not shown) displaying the parameters of the image processing module that corresponds to that area E2.

2-5. Changing Coordinate mₛ

The user can freely change the currently-selected coordinate mₛ for any frame by performing an operation on the input unit 20. Note that as described above, if the coordinate mₛ is changed, the still image that is to be the execution target of the image processing module is changed. Accordingly, changing the coordinate mₛ has the significance of changing the target of image processing.

Specifically, the user first causes the frame whose coordinate mₛ is to be changed to be displayed in the active display window W2. As a result, the history window W3 displays the details of the image processing that was executed on the frame whose coordinate mₛ is to be changed. The history window W3 receives from the user a selection of any one area out of the areas E1 and E2. In response to the user selecting an area E1 or E2, the file management unit 43 changes the coordinate mₛ of the active display frame to the value of the coordinate m of the still image corresponding to that area E1 or E2. Note that the still image corresponding to an area E2 is a still image resulting from the execution of the image processing module that corresponds to that area E2. The change in the coordinate mₛ is immediately reflected in the timeline file.

Incidentally, the display of a frame refers to the display of the still image that has the coordinate mₛ of that frame. Accordingly, changing the coordinate mₛ also has the significance of changing the target of display in the active display window W2. If the coordinate mₛ of the active display frame is changed, the display in the active display window W2 is immediately switched as well.

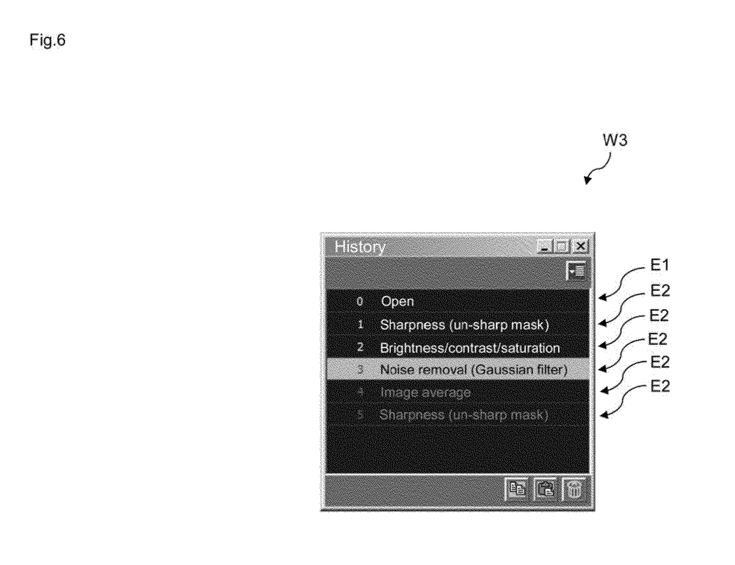

Also, if the coordinate mₛ of the active display frame is changed, the display mode of the areas E1 and E2 in the history window W3 is immediately switched as well. FIG. 6 shows the state of the history window W3 after changing from the coordinate mₛ=5 state shown in FIG. 5 to the coordinate mₛ=3 state. As can be understood by comparing FIG. 5 and FIG. 6, the areas E2 corresponding to the still images of the coordinate (mₛ+1) and subsequent coordinates of the active display frame are displayed in a grayout state. Accordingly, the user can always easily find out which types of image processing modules were used to generate the still image that is currently displayed in the active display window W2.

2-6. Export Processing

Export processing performed by the export unit 46 will be described below. The selected frame group is the target of export processing. Export processing is processing by which the still images having the coordinate mₛ of all frames that are managed in the software management area 3 by the image processing program 2 and are included in the selected frame group are exported from the software management area 3. Export modes include a mode of exporting the still images as a still image file group, a mode of exporting them as a video file, and a mode of creating a material file that includes the still images.

The user can instruct the export unit 46 to execute export processing by performing an operation on the basic screen W1 via the input unit 20. At this time, the export unit 46 allows the user to designate the export mode and the directory address path in the storage unit 30 that is to store the exported output file via an export screen (not shown) displayed in an overlapping manner on the basic screen W1. The export unit 46 detects the operations performed by the user, creates an output file by processing the still images having the coordinate mₛ of all frames included in the selected frame group at that time using the mode designated by the user, and stores the output file in the directory that was designated by the user.

Specifically, if the still image file group has been designated as the export mode, the export unit 46 sequentially outputs the still images having the coordinate mₛ of all frames included in the selected frame group using a still image file format. The output files are automatically given file names by which the order n on the timeline of the original frame is understood. Accordingly, the user or another piece of application software that loads these files can know the arrangement of the output files on the timeline.

On the other hand, if a video file has been designated as the output mode, the export unit 46 creates a video file by successively incorporating the still images having the coordinate mₛ of all frames included in the selected frame group in accordance with the order n on the timeline.

Also, if material creation has been designated as the export mode, the export unit 46 creates a material file incorporating the still images having the coordinate mₛ of all frames included in the selected frame group. The material file is created using a file format that can be opened by another piece of application software, for example, using a document file format. Note that information other than the still images that correspond to the selected frame group is included as necessary in the material file. This information may be determined in advance according to the purpose or the like of the material, and the user may be allowed to input this info as necessary when the export processing is executed.

2-7. Print Processing

Print processing performed by the print control unit 47 will be described below. The selected frame group is the target of print processing. Print processing is processing for the printer connected to the image processing apparatus 1 via the communication unit 50 to print the still images having the coordinate mₛ of all frames included in the selected frame group on a paper medium. Specifically, upon detecting that the user instructs the execution of print processing via the input unit 20, the print control unit 47 provides the data for the still images having the coordinate mₛ of all frames included in the selected frame group at that time to the printer via the communication unit 50. As a result, a sheet on which the still images have been printed is output from the printer.

Note that the frame group that is the target of executing the print processing is not limited to the selected frame group. By allowing the user to designate all frames or any other segment on the active timeline for example via a print setting screen (not shown) displayed in an overlapping manner on the basic screen W1 at the time of executing print processing, the print control unit 47 can execute similar print processing for that kind of frame group.

2-8. Output Record Management

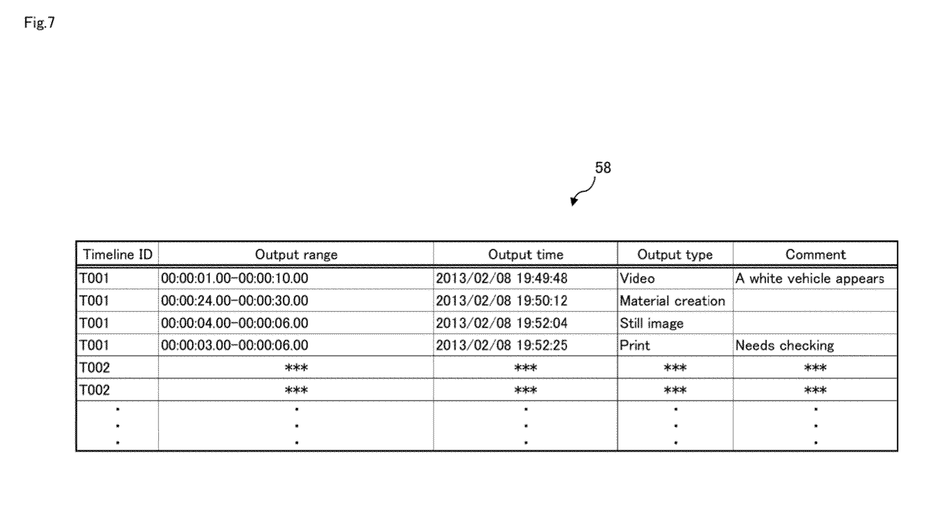

A second record management unit 45 manages the output processing execution record (referred to as the “output record” below) in a second history area 55. In the present embodiment, output processing refers to export processing and print processing. The output management table 58 shown in FIG. 7 is defined in the second history area 55. Each time output processing is executed, the second record management unit 45 creates one new record in the output management table 58.

As shown in FIG. 7, the output management table 58 has five fields, namely “timeline ID”, “output range”, “output time”, “output type”, and “comment”. The timeline ID field is a field for storing the timeline ID of the timeline (hereinafter referred to as the “output timeline”) to which the frame group that was subjected to the output processing (hereinafter referred to as the “output frame group”) belongs. The output range field is a field for storing information specifying the segment on the output timeline to which the output frame group belongs. Note that the segment is specified using the above-described number n (or a value that can be converted to n using a certain rule). Accordingly, the frame IDs of all frames included in the output frame group can be specified by referencing the values in the timeline ID field and the output range field. The output time field stores information indicating the date/time when output processing was executed. The output type field is a field for storing information indicating the output type. Note that there are four types of output types, namely still image, video, material creation, and print, and these correspond to export processing for outputting a still image file group, a video file, and a material file, and to print processing respectively. The comment field is a field for storing a comment regarding the output processing set by the user using a later-described mode. Accordingly, immediately after output processing has been executed, the value of the comment field for the record corresponding to that output processing is “NULL”.

As described above, the second history area 55 stores the values of the frame IDs of all frames included in the output frame group, and in the present embodiment, the image data itself (the still image file) is not stored therein. Accordingly, the amount of storage space in the second history area 55 that is needed to keep output records is reduced.

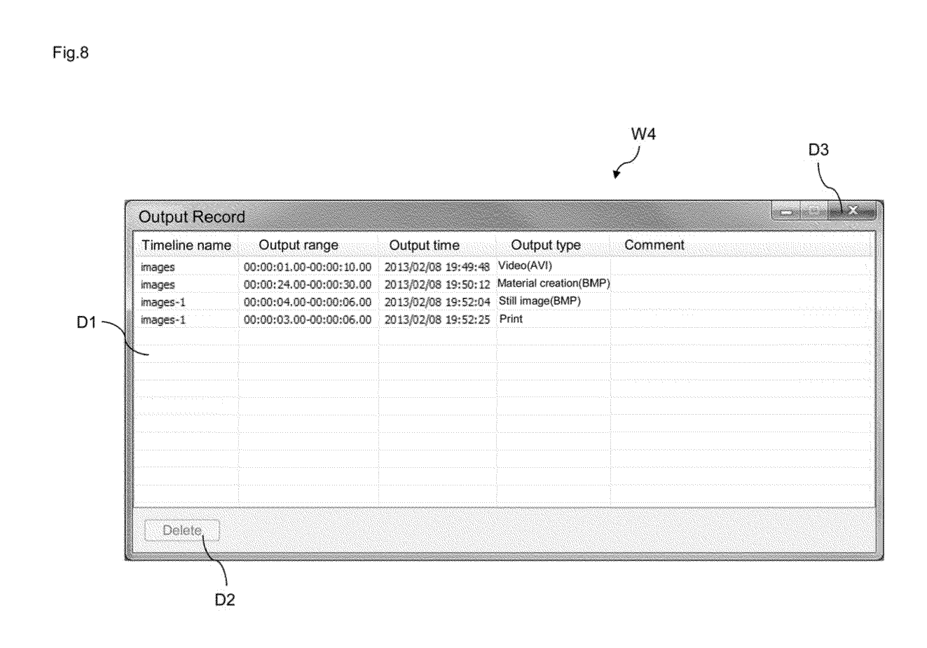

The user can check the output records managed in the output management table 58 at any time. Specifically, upon detecting that the user has performed a predetermined operation on the basic screen W1 via the input unit 20, the display control unit 42 causes the output record screen W4 (see FIGS. 8 to 11) to be displayed in an overlapping manner on the basic screen W1. An output record list D1, a delete button D2, and a cancel button D3 are arranged on the output record screen W4.

The rows included in the output record list D1 have a one-to-one correspondence with the records stored in the output management table 58, or in other words, with all previous output processing as long as the records have not been deleted using a later-described mode. Each row has five columns, namely “timeline name”, “output range”, “output time”, “output type”, and “comment”, and the content displayed in these columns is specified by referencing the output management table 58. The content displayed in the “timeline name” column of each row is the name of the output timeline that corresponds to that row, and the name is specified by referencing the timeline file using the timeline ID of the output timeline stored in the “timeline ID” field in the output management table 58 as a key. Note that the timeline file stores the timeline ID along with the name of the corresponding timeline. Also, the contents displayed in the four columns “output range”, “output time”, “output type”, and “comment” match the values stored in the four fields “output range”, “output time”, “output type”, and “comment” respectively in the output management table 58.

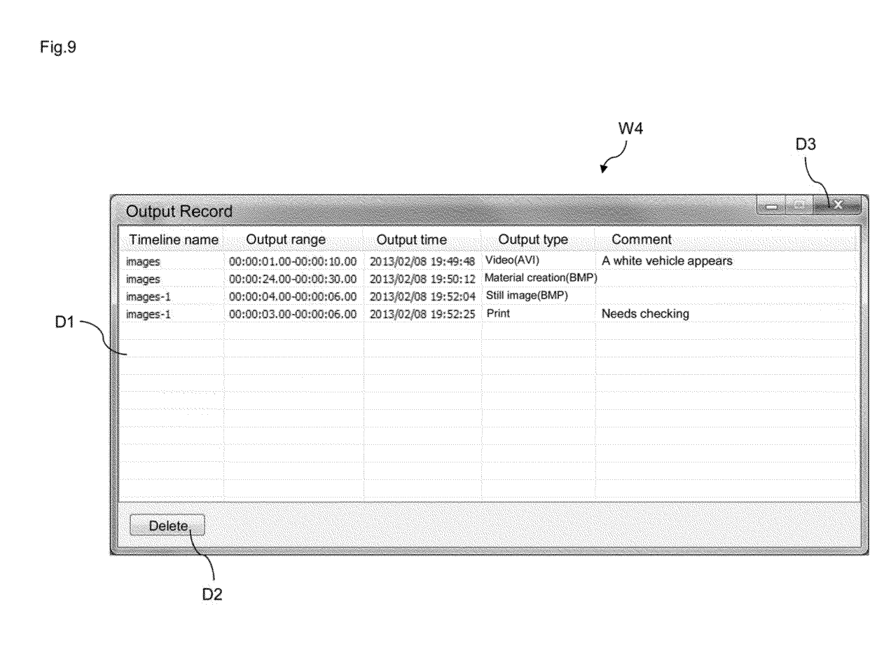

The second record management unit 45 receives, from the user, the input of a character string (may be one character) in the “comment” column for each row in the output record list D1 using a free description format. This function enables the user to freely set a description regarding each output processing as appropriate. For example, if the output processing to which the user is attempting to give a comment was for outputting a frame group in which a white vehicle appears, the user can input a comment such as “A white vehicle appears” (see FIG. 9). Note that the user checking the output record via the output record screen W4 is not limited to being the person who executed the output processing, and there are cases where he or she is an administrator who manages the outflow of image data. In such a case, when an output record that may possibly have involved unauthorized outflow is discovered, the administrator can add a comment such as “Needs checking” to that output record (see FIG. 9).

Upon detecting that the user has input a comment in the “comment” column of a specific row, the second record management unit 45 stores the character string of the comment in the comment field of the record corresponding to that row in the output management table 58. Also, if a comment in the “comment” column is changed by the user and the change operation is detected, the second record management unit 45 causes the content of the change to be reflected in the value in the output management table 58.

Also, the second record management unit 45 receives from the user an operation of selecting any row out of the rows included in the output record list D1. If a specific row in the output record list D1 has been selected, upon detecting that the user has pressed the delete button D2 via the input unit 20, the second record management unit 45 deletes the record corresponding to the row that has been selected in the output record list D1 at that time (hereinafter referred to as the “selected row”) from the output management table 58. In other words, the output record corresponding to the selected row at the point in time when the delete button D2 is pressed is deleted from the second history area 55. At the same time, the display control unit 42 deletes the selected row that is displayed in the output record list D1. Note that if no row has been selected in the output record list D1, the delete button D2 is disabled and a deletion instruction cannot be received (see FIG. 8).

Also, when the user selects a specific row in the output record list D1, the control unit 40 switches the output timeline corresponding to the selected row to the active timeline and switches the output frame group corresponding to the selected row to the selected frame group. As a result, the divided areas that correspond to the output frame groups corresponding to the selected rows (divided areas A1) are displayed on the timeline bar T5 using a different display format to distinguish them from the divided areas corresponding to the other frame groups (divided areas A2) on the same output timeline. Accordingly, the user selects a specific row in the output record list D1, and by subsequently referencing the timeline bar T5, the user can easily understand the position on the timeline of the output frame group that was subjected to the output processing corresponding to the selected row.

Also, the timeline bar T5 receives a user operation when the output record screen W4 is being displayed as well. Accordingly, the user can cause the output frame group that was subjected to the output processing to be displayed in the active display window W2 by selecting, on the timeline bar T5, the divided area Al that visually indicates a correspondence to the output frame group that was subjected to the output processing. Accordingly, the user can easily check image data that he or she outputs, or that may possibly have been taken out by someone.

The above-described output record screen W4 is closed by the display control unit 42 when the cancel button D3 is pressed by the user via the input unit 20.

2-9. Timeline and Frame Deletion

The user can delete still image files stored in the original image area 51 and the processed file area 52 in units of timelines or units of frames. This deletion processing is executed by the file deletion unit 48.

Deletion processing in units of timelines will be described first. The basic screen W1 receives an instruction to delete the active timeline from the user. Accordingly, by first operating the window selection pull-down menu T1, the user sets the timeline that is to be deleted as the active timeline, and in this state, inputs a deletion instruction. The file deletion unit 48 receives the deletion instruction from the user and searches for the timeline file storing the timeline ID of the active timeline in the file management area 53. Next, by referencing the timeline file that was found, the file deletion unit 48 specifies all of the still image files belonging to the active timeline and deletes all of those still image files from the original image area 51 and the processed file area 52. At the same time, the file deletion unit 48 deletes the found timeline file from the file management area 53.

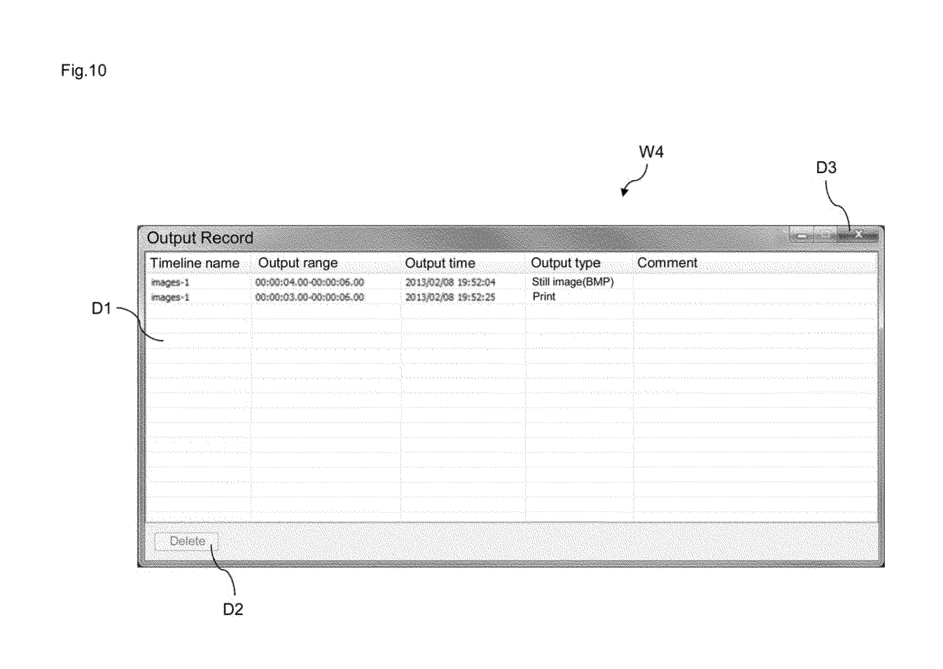

Also, when executing deletion processing in units of timelines, the second record management unit 45 deletes the output records corresponding to the active timeline that is to be deleted from the second history area 55. Specifically, the second record management unit 45 deletes the records holding the timeline ID of the active timeline in the timeline ID field from the output management table 58. Note that FIG. 10 shows the output record screen W4 after the timeline named “images” has been deleted from the state shown in FIG. 8.

Deletion processing in units of frames will be described next. The basic screen W1 receives an instruction to delete the selected frame group from the user. Accordingly, by first operating the timeline bar T5, the user selects the frame group that is to be deleted as the selected frame group, and in that state, inputs the deletion instruction. The file deletion unit 48 receives the deletion instruction from the user and searches for the timeline file storing the timeline ID of the active timeline in the file management area 53. Next, by referencing the timeline file that was found, the file deletion unit 48 specifies all of the still image files belonging to the selected frame group and deletes all of those still image files from the original image area 51 and the processed file area 52. At the same time, the file deletion unit 48 deletes the image file IDs of all of the still image files belonging to the selected frame group from the timeline file that was found. Also, at the same time, the file deletion unit 48 re-numbers the order n on the timeline of the non-selected frame groups as appropriate in the timeline file that was found. For example, if ten frames from n=1 to 10 are stored on the active timeline and three frames from n=3 to 5 are deleted, the order n of the frames of n=1 and 2 that precede the deleted frames on the timeline does not change, but the order n of the subsequent frames from n=6 to 10 changes to 3 to 7. Accordingly, if deletion processing in units of frames is executed, the frame IDs of the non-selected frame groups are changed as appropriate.

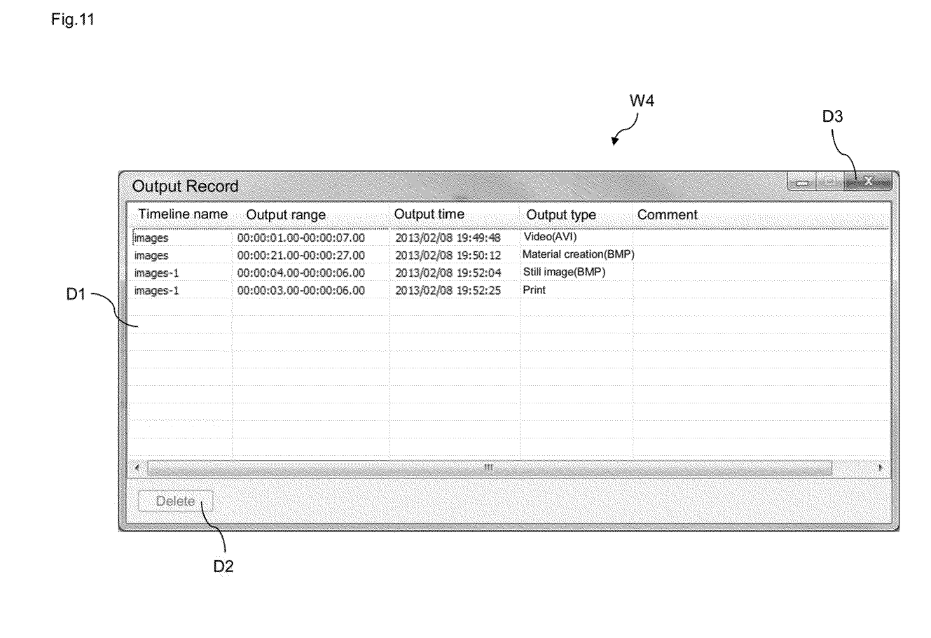

Also, when executing deletion processing in units of frames, the second record management unit 45 deletes the output records corresponding to the selected frame group that is to be deleted from the second history area 55. Specifically, the second record management unit 45 extracts the records holding the timeline ID of the active timeline in the timeline ID field (hereinafter referred to as the “target record”) from the output management table 58. Then, it is determined whether or not the segment specified by the value of the output range field in the target record overlaps the segment to which the selected frame group that is to be the target of deletion belongs on the active timeline. If an overlapping segment has been detected, the second record management unit 45 deletes the number n in the overlapping segment from the output range field in the target record. Also, as described above, if deletion processing in units of frames is executed, the frame IDs of the non-selected frame groups can be re-numbered. Accordingly, in order to handle the re-numbering, the second record management unit 45 determines whether or not the segment specified by the value in the output range field of the target record overlaps the segment that the non-selected frame groups belong to on the active timeline. Then, if an overlapping segment has been detected, the second record management unit 45 changes the numbers n in the overlapping segment included in the output range field of the target record to the re-numbered numbers n. Note that FIG. 11 shows the output record screen W4 after the frames of the segment “00:00:03.00-00:00:05.00” in “images” have been deleted from the state shown in FIG. 8.

Accordingly, if the frame IDs of pieces of image data stored in the original image area 51 and the processed file area 52, or in other words, the frame IDs managed in the file management area 53 are changed, the frame IDs in the second history area 55 that stores the output records are changed as well. That is to say that the frame IDs in the second history area 55 are changed in coordination with the frame IDs managed in the file management area 53. Accordingly, even if the frame IDs of pieces of image data stored in the original image area 51 and the processed file area 52 are changed, no discrepancy will occur in the information regarding the output frame group managed in the second history area 55.

3. Application

The image processing program 2 can handle image processing with respect to various types of video, and for example, it can be used in the field of analyzing surveillance video from a security camera in order for an organization such as the police to investigate an incident. That is to say, if this type of surveillance video is evidentiary material in an investigation and the record management function of the above-described image processing is used, it is possible to record the way in which the video that is evidentiary material resulting from the image processing was created. In particular, it is possible to reliably manage unauthorized operations such as tampering as well. Furthermore, if the above-described output record management function is used, it is possible to easily manage the outflow of confidential surveillance video as well.

4. Features

With the above-described embodiment, the user can execute output processing on a selected frame group. Also, upon executing this output processing, an output record is kept that includes the frame IDs of the frames included in the selected frame group that were subjected to the output processing. That is to say that an output record is kept that specifies the target of the output processing in units of frames. Furthermore, the output record is presented to the user as the output record screen W4. Accordingly, the user can find out which frames on the timeline of the video were output. As a result, the outflow of image data can be appropriately managed in a situation where video data is handled.

5. Variations

Although an embodiment of the present invention has been described above, the present invention is not limited to the above-described embodiment, and various modifications are possible within a scope that does not deviate from the gist of the invention. For example, the following modifications are possible.

5-1

The appearance of the timeline bar T5 is not limited to the above-described mode. For example, the timeline bar T5 need not be one straight line, and for example, it can be changed to a curved line, or multiple straight lines.

5-2

A field or column indicating the name of the user who executed the output processing may be provided in the output management table 58 and the output record list D1. Note that the determination of the name of the user who executed the output processing may be realized by issuing an account for using the image processing program 2 to the user and not enabling startup of the image processing program 2 unless the issued account has been input. In this case, the user who is logged in at the time of executing the output processing is recorded as the person who has executed the output processing.

5-3

With the above-described embodiment, anyone can open the output record screen W4, but it is possible to allow only an administrator to open it. Alternatively, it is possible to allow anyone to open the output record screen W4, but allow only the administrator to execute record deletion.

Note that the determination of whether a user is an administrator or not can be performed by obtaining from the user the input of a password known only by the administrator when the user attempts to open the output record screen W4, or when the user attempts to delete a record for example. Another example is conceivable in which an account for using the image processing program 2 is issued to the user and the image processing program 2 cannot be started unless the issued account is input. Then, it is possible to allow only a person who is logged in with an account having administrative authority to open the output record screen W4 or delete a record.

5-4

In the above-described embodiment, the output records are stored in units of frames. However, the output records may be stored in more detail in units of still images belonging to the frames. For example, the frame IDs of the frames included in the output frame group, and the values of the coordinate m of the still images that were output are stored in the output management table 58. Furthermore, when a specific row has been selected by the user in the output record list D1, the coordinates mₛ of the output frame group corresponding to that row may all be changed to the coordinates m at the time of executing the output processing. According to this mode, when checking the content of the output frame group in the active display window W2, the user can easily check the still images having the coordinates m that correspond to the target of the output processing while operating the timeline bar T5. Also, by referencing the history screen W3 at this time, the user can easily understand what kind of image processing has been performed on the still images having the coordinates m that were subjected to the output processing.

5-5

When a frame ID is changed in the file management area 53 in the above-described embodiment, the frame ID in the second history area 55 is changed as well. Also, the time of executing the deletion processing in units of frames was given as a case where the frame ID in the file management area 53 is changed. However, the frame ID in the second history area 55 may be changed in the case where the frame ID in the file management area 53 is changed according to another condition as well. For example, a case is conceivable in which it is possible to add a frame to a pre-existing timeline, and according to that addition, the frame IDs of the frames on that timeline are automatically changed. Alternatively, a case is conceivable in which it is possible for the user to manually change the frame IDs of pre-existing frames.

1. An image processing apparatus comprising:
a storage unit that has a first storage area and a second storage area;
an output processing unit configured to execute output processing for exporting and/or printing one or more frames selected by a user from a video stored in the first storage area;
a record storage unit configured to store, in the second storage area, a record of the output processing that includes an identifier for each frame that was subjected to the output processing; and
a display control unit configured to reference the second storage area and display a record screen displaying the record of the output processing.

2. The image processing apparatus according to claim 1,
wherein the display control unit is configured to display a timeline object that schematically illustrates a timeline of the video,
when the user selects a specific area on the timeline object, the display control unit is configured to display a frame corresponding to the specific area, and
when the user selects a record of specific output processing on the record screen, the display control unit is configured to display, on the timeline object, an area corresponding to the frame that was subjected to the specific output processing, such that the area is distinguished from areas corresponding to the other frames.

3. The image processing apparatus according to claim 1, further comprising:
an image processing unit configured to carry out a type of image processing selected by the user from a plurality of types of image processing on one or more frames selected by the user from the video stored in the first storage area.

4. The image processing apparatus according to claim 2, further comprising:
an image processing unit configured to carry out a type of image processing selected by the user from a plurality of types of image processing on one or more frames selected by the user from the video stored in the first storage area.

5. The image processing apparatus according to claim 1,
wherein image data for the frame that was subjected to the output processing is not included in the record of the output processing stored in the second storage area.

6. The image processing apparatus according to claim 2,
wherein image data for the frame that was subjected to the output processing is not included in the record of the output processing stored in the second storage area.

7. The image processing apparatus according to claim 3,
wherein image data for the frame that was subjected to the output processing is not included in the record of the output processing stored in the second storage area.

8. The image processing apparatus according to claim 4,
wherein image data for the frame that was subjected to the output processing is not included in the record of the output processing stored in the second storage area.

9. The image processing apparatus according to claim 1, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

10. The image processing apparatus according to claim 2, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

11. The image processing apparatus according to claim 3, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

12. The image processing apparatus according to claim 4, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

13. The image processing apparatus according to claim 5, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

14. The image processing apparatus according to claim 6, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

15. The image processing apparatus according to claim 7, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

16. The image processing apparatus according to claim 8, further comprising:
a change unit configured to change the identifier of one or more frames included in the video that is stored in the first storage area,
wherein the record management unit is configured to, in accordance with the change, change the identifier of the one or more frames included in the record of the output processing stored in the second storage area.

17. A non-transitory computer-readable medium storing an image processing program for causing a computer having a first storage area and a second storage area to execute steps of:
executing output processing for exporting and/or printing one or more frames selected by a user from a video stored in the first storage area;
storing, in the second storage area, a record of the output processing that includes an identifier for each frame that was subjected to the output processing; and
referencing the second storage area and displaying a record screen that displays the record of the output processing.

18. The non-transitory computer-readable medium according to claim 17, the program causing the computer to further execute steps of:
when the user selects a specific area on the timeline object, displaying a frame corresponding to the specific area, and
when the user selects a record of specific output processing on the record screen, displaying, on the timeline object, an area corresponding to the frame that was subjected to the specific output processing, such that the area is distinguished from areas corresponding to the other frames.

19. An image processing method for executing image processing using a computer that has a first storage area and a second storage area, the method comprising:
executing output processing for exporting and/or printing one or more frames selected by a user from a video stored in the first storage area;
storing, in the second storage area, a record of the output processing that includes an identifier for each frame that was subjected to the output processing; and
referencing the second storage area and displaying a record screen that displays the record of the output processing.

20. The image processing method according to claim 19, further comprising:
when the user selects a specific area on the timeline object, displaying a frame corresponding to the specific area, and
when the user selects a record of specific output processing on the record screen, displaying, on the timeline object, an area corresponding to the frame that was subjected to the specific output processing, such that the area is distinguished from areas corresponding to the other frames.
